(19) United States
(12) Patent Application Publication
(10) Pub. No.: US 2016/0267564 A1
(43) Pub. Date: Sep. 15, 2016

(54) Process for Increasing Referral Fees Paid by Merchants to Affiliates and Process for Collecting email addresses

(71) Applicant: FROMAN INDUSTRIES CORP., Southwest Ranches, FL (US)

(72) Inventor: Abe Smilowitz, Southwest Ranches, FL (US)

(73) Assignee: FROMAN INDUSTRIES CORP., Southwest Ranches, FL (US)

(21) Appl. No.: 15/062,042

(22) Filed: Mar. 4, 2016

Related U.S. Application Data
(60) Provisional application No. 62/128,349, filed on Mar. 4, 2015.

(51) Int. Cl. G06Q 30/06; G06Q 30/02; G06Q 20/10; H04L 12/58; G06F 17/30

(52) U.S. Cl. CPC G06Q 30/0613; H04L 51/046; G06F 17/30867; G06Q 20/102; G06Q 30/0276; H04L 51/08; G06Q 30/0201; G06Q 30/0277

(57) ABSTRACT

Middleware can maximize referral fees paid by merchants to affiliates by applying a process. The process ranks merchants according to their referral schedules and conversion rates. Next, when the referrer identifies a lead for the merchants, the referrer checks if the lead is not an existing subscriber of a top-ranked merchant before referring the lead to the merchant. And, if the lead is a subscriber, then the referrer can check to see if the lead is a subscriber to a second-ranked merchant, then refer the lead to the second-ranked merchant if the subscriber is not already a member. The process can be applied particularly well to only referral based businesses such as online dating sites.

### CROSS-REFERENCE TO RELATED APPLICATIONS

This application claims the benefit of U.S. Provisional Application No. 62/128,349, filed Mar. 4, 2015, which is hereby incorporated by reference.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to referral-based marketing and methods for collecting sales-lead data and particularly to methods for collecting email addresses.

2. Description of Related Art

Affiliate marketing involves a merchant paying an affiliate a referral fee after a sales lead (sometimes referred to as a “lead”) sent to the merchant by the affiliate completes a business transaction with the merchant. An overview of traditional affiliate marketing systems is provided by HowStuffWorks.com. See Tom Harris “How Affiliate Programs Work” 11 Aug. 2000.

To attract sales leads for a merchant, an affiliate of the merchant can produce content that is interesting to potential customers of the merchant. For example, an affiliate of website developer can publish a webpage that discusses how to screen and hire a website developer. Then potential customers of the merchant, i.e. sales leads, may come to the affiliate's website to learn how to screen and hire a website developer. The webpage can include a hyperlink that refers readers of the webpage to a landing page of the merchant. The URL of the hyperlink can include data that identifies the referring affiliate to the merchant. The merchant then can provide information on the landing page to convince the sales lead to become a customer of the merchant. The process of convincing a sales lead to become a customer is called “conversion”. When the customer completes a transaction with the merchant, the merchant remits a referral fee to the affiliate.

An existing relationship between a lead and a merchant can bar an affiliate from collecting a referral fee from the merchant. Most merchants require agreements with affiliates that state that the merchant will not pay affiliates for referring existing customers to the merchant. So, when the affiliate refers a lead to the merchant's landing page, the lead moves outside of the affiliate's control. Accordingly, if the lead is referred to a first merchant and the lead has an existing relationship with the first merchant, the affiliate is no longer able to refer the lead to a second merchant that may have no relationship with the lead.

In the hyperlinks used in existing affiliate marketing systems, the hyperlink directs a browser to a webpage affiliate with one and only one particular merchant.

Another issue with existing affiliate marketing system is that the hyperlinks to a particular merchant cannot be easily changed. If a merchant changes its referral payment, an affiliate may want to change the merchant to whom the affiliate refers leads. To enact the change, the affiliate needs to change the hyperlink to point to the new merchant. The updating process for the hyperlinks becomes increasingly daunting as the number of hyperlinks increases and as the frequency of changes in referral payments increases.

As a result of these issues in referral marketing systems, the amount of total referrals paid to a given affiliates may be reduced from the affiliate's full potential.

### BRIEF SUMMARY OF THE INVENTION

An object of the invention is to provide a process for gathering sales lead data by encouraging affiliates to share the sales lead data in order to increase referral fees paid by merchants to the affiliates.

In accordance with the object of the invention, a process for increasing referral fees from merchants is provided. The process utilizes a database. The database stores merchant data that describes the merchants. The merchant data can include an identity of each merchant and a referral schedule for each respective merchant. The referral schedule describes how the merchant pays affiliates for leads whom the merchant converts to customers. In the next step, a lead identity of each lead is obtained. The lead identity is data that uniquely identifies the lead. An email address is an example of a lead identity. The next step involves sorting the merchants in the database by conversion related criteria. The conversion related criteria could be an amount paid per converted sales lead. In addition, the criteria can include additional factors such as the rate at which a merchant converts leads that are provided to it. The next step is querying the highest rated merchant to see if the lead already is a member of the merchant. If the lead is not already a member, then the lead is passed to the merchant. If the lead is already a member, then the lead is passed to the next highest rated merchant. The list of merchant is queried in the order that the merchants are rated until the lead is passed.

The process of the invention can be embodied as middleware running on a server. The software is middleware because it connects affiliates and their sales leads to merchants.

To market for a group of merchants, in contrast to marketing for one merchant, the content being generated by the affiliates should be generic for both merchants. By using generic content, a sales lead is lead to expect a member of the targeted genus. And, because no single merchant is targeted, the potential lead will not be offended if he or she is referred to a different merchant.

Affiliates are free to create content to generate leads. Content can be presented in a variety of media. For example, the content could be presented on a webpage, a social media posting, or an email. The content can include a hyperlink to a landing page that is maintained by the middleware. The hyperlink includes a URL of the landing page as well as an affiliate id. The middleware provides the affiliate with an affiliate id after the affiliate registers with the middleware.

A sales lead who reads the content can choose to follow the hyperlink that is provided with the content. When the lead selects the hyperlink, a webserver of the middleware transmits a landing page to the sales lead's web browser. The webserver also parses the affiliate ID from the URL. The middleware then stores a relationship between a customer record for the sales lead and the affiliate who referred the sales lead to the landing page.

To increase the total referrals paid to affiliates, factors in addition to the referral amount can be considered. For example, the conversation rate of each merchant can be tracked by the middleware and then considered when sorting the merchants.

The process according to the invention is particularly applicable to affiliate marketing systems for online dating services. A middleware provider creates a database. The database stores information about online dating services. Particularly, the database includes an amount paid by each respective dating service to an affiliate for referring a sales lead who becomes a customer of the particular online dating service. The process calls for creating an advertisement that is generic for each of the online dating services. For example, an affiliate could produce a content page that contains an advertisement for online dating services generally. The advertisement should not promote only one particular online dating service. A potential customer of the online dating services reads the affiliate's content, clicks a hyperlink, and loads a landing page of the middleman. On the landing page, the lead enters information for the online dating services. In particular, the sales lead provides his or her email address to middleware by completing the forms on the landing page. The middleware ranks the dating services based on the referral fee paid by the online dating service to affiliates when a lead is converted to a customer of the online dating service. The middleware queries the highest ranked online dating service to determine if the lead is already a member of the highest ranked online dating service. If the lead is not a member, then the lead is passed to the highest ranked online dating service. If the lead is a member of the highest ranked online dating service, then the lead is passed to the second highest ranked online dating service.

In accordance with the objects, the invention includes a process for sending leads to merchants with whom the leads are not already members. The process includes querying a merchant if a lead is not already a customer of said merchant before referring said lead to said merchant.

Although the invention is illustrated and described herein as embodied in a process for maximizing referral fees, the invention should not be limited to the details shown in those embodiments because various modifications and structural changes may be made without departing from the spirit of the invention while remaining within the scope and range of equivalents of the claims.

The construction and method of operation of the invention and additional objects and advantages of the invention is best understood from the following description of specific embodiments when read in connection with the accompanying drawings.

### BRIEF DESCRIPTION OF THE SEVERAL VIEWS OF THE DRAWING

FIG. 1 is a table illustrating an application programming interface of a first merchant.

FIG. 2 is a table illustrating an application programming interface of a second merchant.

FIG. 3 is a layout view of the tables in a middleware database.

FIG. 4 is a flow chart showing a method of adding a merchant to middleware.

FIG. 5 is a flow chart showing a method of an affiliate joining middleware.

FIG. 6 is a flow chart showing a method of referring a lead from an affiliate to a merchant using middleware.

FIG. 7 is a schematic drawing of a computer network according to the invention.

### DETAILED DESCRIPTION OF THE INVENTION

A preferred embodiment of the invention is middleware that helps affiliate marketers and vendors to increase their conversion of potential customers. The middleware will be explained below using the example of affiliates who generate leads for online dating services.

In a preferred embodiment, as shown in FIG. 7, the middleware 10 includes a computer server 11. The computer server 11 hosts a relational database 12. In addition, the computer server 11 hosts a webserver 13 that receives requests from client computers and replies with webpages. The webpages are preferably dynamic webpages that are formed using data taken from the relational database 12. The webserver 13 is connected to a TCP/IP network, preferably the Internet 21.

A user of the middleware 10 establishes a relationship with merchants 20A and 20B. Merchant 20A and merchant 20B are competitors. That is, both sell competing goods and or services. In the example, merchant 20A and merchant 20B both are online dating services. Merchant 20A and merchant 20B charge their respective members a monthly membership fee to utilize their services.

In this example, merchant 20A pays an affiliate a referral fee ($x) when a lead is referred by the affiliate and the lead joins (i.e. pays the membership fee) the online dating service of Merchant 20A. Merchant 20A publishes an application programming interface (API) 100 that describes data that an affiliate can provide to facilitate payment of the referral fee.

Similarly, merchant 20B pays an affiliate a referral fee ($y) when a lead is referred by the affiliate and the lead joins (i.e. pays the membership fee) the online dating service of merchant 20B. Merchant 20B publishes an application programming interface (API) 200 that describes data that an affiliate can provide to facilitate payment of the referral fee.

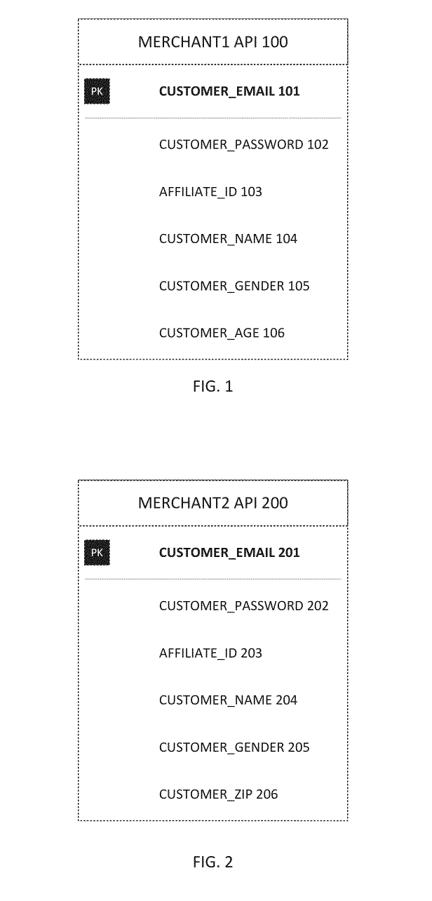

FIG. 1 is a table showing the data requested by merchant 20A's API 100. The customer email field 101 stores the lead/referral/customer's email address. The merchant 20A requires that the data stored in the customer email field 101 is unique. That is, the same email address cannot be used to identify more than one record. A customer_password field 102 stores a password of the customer. An affiliate ID field 103 stores data that identifies the affiliate who referred the customer. A customer name field 104 stores a name of the customer. A customer gender field 105 stores a gender of the customer. A customer age field 106 stores an age of the customer. The fields 101, 102, 103, 104, 105, and 106 are related to each other to describe a customer record.

FIG. 2 is a table showing the data requested by merchant 20B's API 200. The API 200 is similar to the API 100 and shares some fields but not all fields. The customer email field 201 stores the lead/referral/customer's email address. The merchant 20B requires that the data stored in the customer email field 201 is unique. That is, the same email address cannot be used to identify more than one record. A customer password field 202 stores a password of the customer. An affiliate ID field 203 stores data that identifies the affiliate who referred the customer. A customer name field 204 stores a name of the customer. A customer gender field 205 stores a gender of the customer. A customer_age field 206 stores an age of the customer. The fields 201, 202, 203, 204, 205, and 206 are related to each other to describe a customer record.

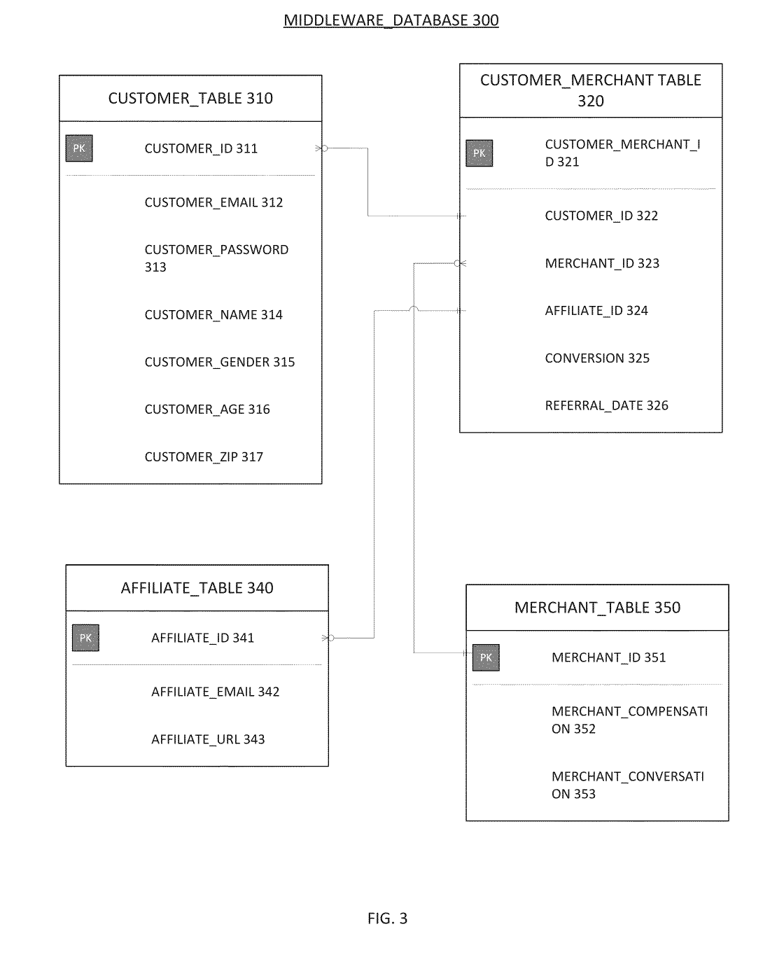

FIG. 3 is a relational database model depicting a middleware database 300 hosted within the relational database 12. The middleware database 300 stores and relates the data describing the leads/referrals/customers, the merchants, and the affiliates.

A customer table 310 is included in the middleware database 300. The customer table 310 stores data describing the leads/referrals/customers. A record is created in the customer table 310 for each customer. The customer table 310 includes a customer ID field 311 that is a primary key. A customer email field 312 stores an email for a given customer. A customer password field 313 stores a password for a given customer. A customer name field 314 stores a name of a given customer. A customer gender field 315 stores a gender of a given customer. A customer age field 316 stores an age of a given customer. A customer zip code field 317 stores a postal code of a given customer. The fields 311, 312, 313, 314, 315, 316, and 317 for a given customer are related.

An affiliate table 340 is included in the middleware database 300. The affiliate table 340 stores data describing each affiliate. A record is created in the affiliate table 340 for each affiliate. The affiliate table 340 includes an affiliate ID field 341 that is a primary key. An affiliate email field 342 in the affiliate table 340 stores an email address for contacting a respective affiliate. An affiliate URL field 343 in the affiliate table 340 stores a uniform resource locator (URL) of a respective affiliate. The fields 341, 342, and 343 for a given affiliate are related.

A merchant table 350 is included in the middleware database 300. The merchant table 350 stores data describing each merchant. A record is created in the merchant table 350 for each merchant. The merchant table 350 includes a merchant ID field 351 that is a primary key. A merchant compensation field 352 in the merchant table 350 stores data regarding how much a merchant pays an affiliate. For example, the merchant compensation field 352 can store an amount to be paid each month to an affiliate for a converted lead sent by an affiliate. A merchant conversion field 353 stores data describing how often a merchant converts a lead from an affiliate to a member of the merchant. The merchant conversion field 353 can be a percentage that is calculated based on data tracked by the middleware. The fields 351, 352, and 353 for a given affiliate are related.

A customer affiliate merchant junction table 320 is included in the middleware database 300. The customer affiliate merchant junction table 320 associates a customer with an affiliate and with a merchant. A record is created in the customer affiliate merchant junction table 320 for each lead that is referred to a merchant by an affiliate. The middleware database 300 includes a customer affiliate merchant ID field 321 that is a primary key. A customer ID field 322 is included in the customer affiliate merchant junction table 320. The customer ID field 322 stores a customer ID of a customer who has been referred to a merchant by an affiliate. The customer ID stored in the customer ID field 322 matches the customer ID of the customer, which is stored in the customer ID field 311 of the customer table 310. A merchant ID field 323 stores a merchant ID of a merchant to whom a customer is being referred by an affiliate. The merchant ID stored in the merchant ID field 323 matches the merchant ID of the merchant, which is stored in the merchant ID field 351 of the merchant table 350. An affiliate ID field 324 stores an affiliate ID of an affiliate who referred the customer to the merchant. The affiliate ID stored in the affiliate ID field 324 matches the affiliate ID of the affiliate, which is stored in the affiliate ID field 341 of the affiliate table 340. A conversion field 325 stores data that indicates whether or not the merchant converted the lead to a customer.

FIG. 4 illustrates a preferred embodiment of a method of adding a merchant to the middleware database 300. The method begins at the start 401. Next, in step 402, the middleware database 300 is queried to determine if the merchant already has an associated record in the merchant table 350. If the merchant does not have an existing record, in step 403, a record is created in the merchant table 350 for the merchant. If the merchant does have an existing record, then no record needs to be added. In step 404, the middleware receives the API from the merchant. In step 405, the middleware parses the API and creates a list of fields that the merchant requests customers to provide. In steps 406-412, the middleware checks that each of the fields from the merchant's API are included in the customer table 310. In step 408, a field from the merchant API that is not included in the customer table 310 is added to the customer table 310. The merchant may require that a particular field be provided when a lead is submitted to the merchant. When a field is required by the merchant, the field in the customer table is marked as required. When all of the fields from the merchant's API are included in the customer table, the process reaches the end 413.

In addition, when the middleware adds a merchant, the compensation that the merchant pays an affiliate for a lead, or more typically, for a lead that is converted into a member is stored in the merchant compensation field 352 of the merchant table.

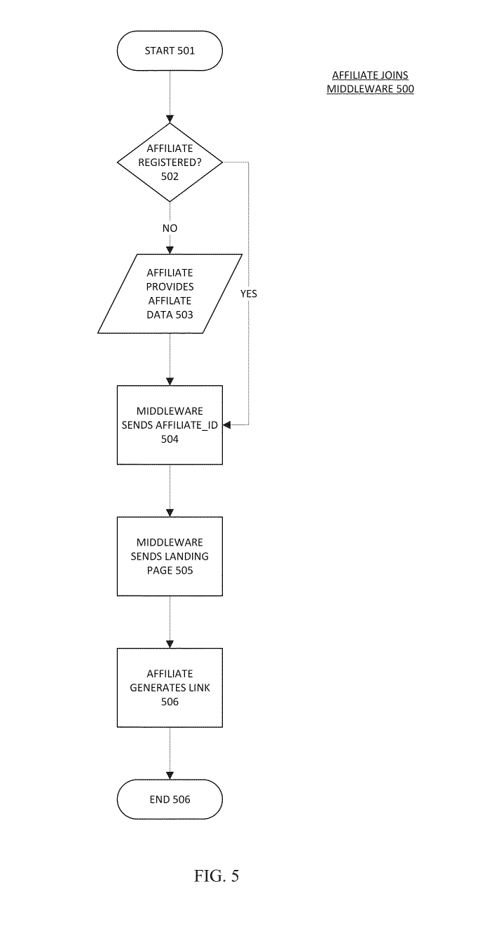

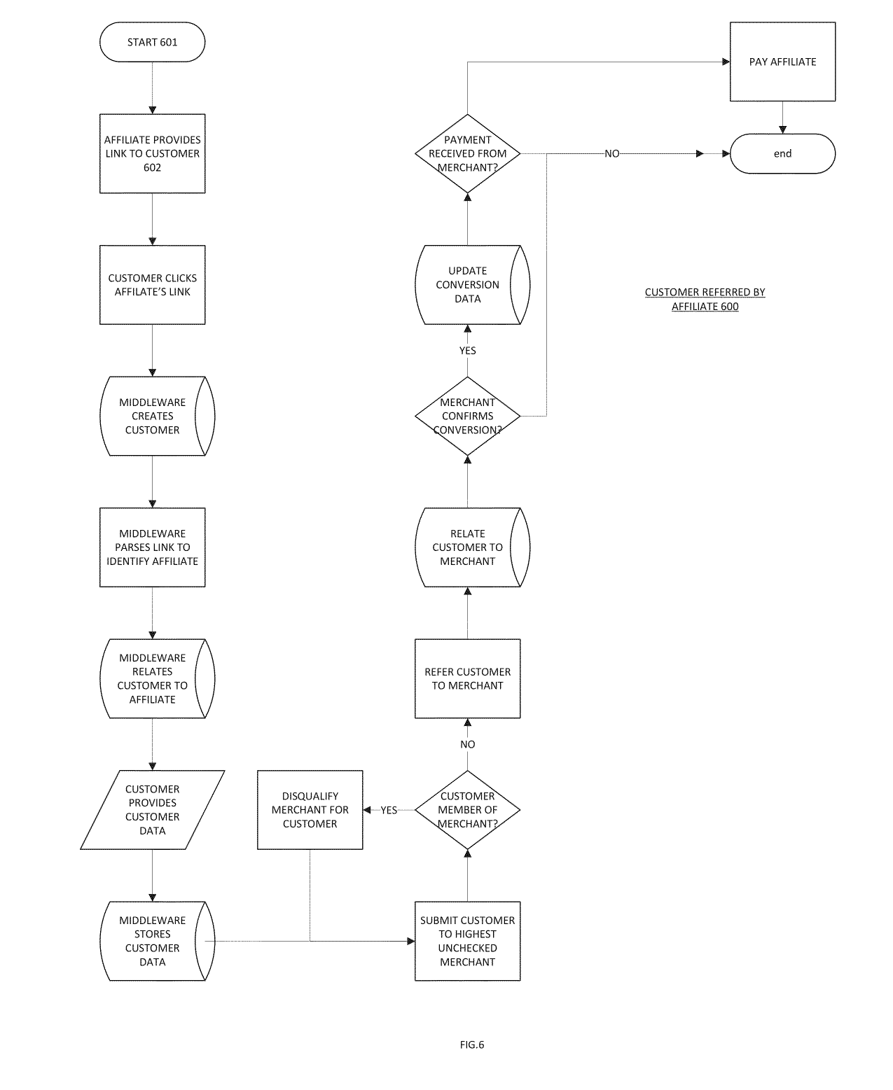

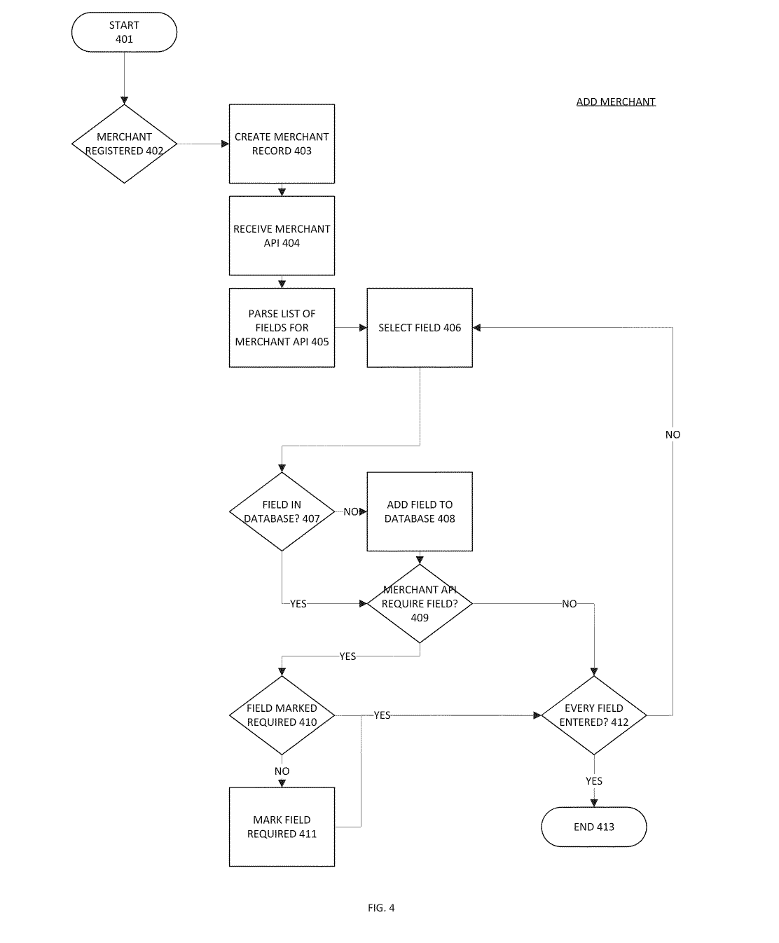

FIG. 5 illustrates a preferred embodiment of a method for the middleware to add an affiliate. The process begins in step 501. In step 502, the middleware queries the affiliate table 340 to check if a record corresponding to the affiliate already exists. If a record for the affiliate does not exist, then, in step 503, the affiliate provides data describing the affiliate to the middleware in order to complete the fields 341, 342, and 343 of the affiliate table 340. After the affiliate is registered with the middleware, the middleware transmits an affiliate ID of the affiliate from the affiliate ID field 341.

The middleware produces a landing page. A preferred embodiment of a landing page is a webpage. The webpage has a URL. A unique URL is provided for each affiliate. The landing page uses forms and scripting to request information from a lead who browses to the landing page. The information is used to fill the fields 312, 313, 314, 315, 316, and 317 of the customer table 310. In the preferred embodiment, the minimum amount of information that is required is the email address of the lead. The content of the landing page is generic for all of the merchants.

In step 505, the middleware send the URL of the landing page to the affiliate.

In step 506, the affiliate generates content containing a hyperlink. The hyperlink is the URL of the landing page. A preferred example of content is a webpage. Additional examples of content could be an email or a social media posting or even a traditional (i.e. paper) mailer. An effective affiliate generates content that potential customers of merchants will want to view. When the lead clicks on the hyperlink, the lead's browser requests the landing page from the webserver 13. The webserver 13 parses the URL to determine which affiliate referred the lead to the landing page. Next, the webserver 13 transmits the landing page to the lead.

After a lead enters the lead's information in the landing page, the middleware's webserver copies the lead's data into the customer table 310. In addition, a customer affiliate merchant record in the customer affiliate merchant table 320 is created to relate the lead to the affiliate that referred the lead to the landing page.

After the middleware stores the data of the lead, the middleware ranks the merchants. In a preferred embodiment, the middleware ranks the merchants by the amount that the merchant pays an affiliate when a lead is converted to a customer of the merchant. In an alternate embodiment, the middleware considers additional factors such as conversion rate when ranking the merchants.

The middleware then submits the lead to the merchant by transmitting the lead's data from the customer table 310 to the merchant as provided by the merchant's API. If the lead already is a member of the merchant, then the merchant replies to the middleware that the lead already has an account with the merchant. The middleware then submits the lead's information to the next highest ranking merchant. The middleware continues submitting the lead to merchants based on their rankings until a merchant is found in which the lead is not yet a member. The middleware then passes the lead to the first available merchant and the lead can choose to join the merchant.

In a first embodiment, the middleware includes the affiliate's information with the leads. With the affiliate's information, the merchant remits a referral fee directly to the affiliate when the lead is converted into a customer. In an alternate embodiment, the middleware indicates to the merchant that the middleware is the affiliate. The merchant then pays the middleware a referral fee for converted leads. The middleware forwards the referral fee to the affiliate. The middleware tracks how many leads are converted by each merchant. The middleware can use the conversion data to rank the merchants.

A test of this system found that the amount of referral fees being paid for a similar set of leads was over 300% greater than traditional systems that merely passed leads to one merchant.

The customer data stored in the customer table has value. Lists of email addresses can be sold themselves to marketing companies. A list of emails with additional demographics such as location (i.e. mailing zip code) and merchant interest can be sold for more money than an unclassified list. The list of leads can be recycled by the middleware itself and used to target additional marketing campaigns, which can generate referrals to the middleware.

Affiliates who otherwise covet and do not share leads are given an incentive to share their leads with the middleware in order to increase their referral fees by increasing the conversion rate per lead.

What is claimed is:

1. A process for maximizing referral fees, which comprises:
creating a database, said database storing a first merchant identity, a second merchant identity, a first-merchant referral schedule, and a second-merchant referral schedule, said first-merchant referral schedule being related to said first merchant identity, and said second-merchant referral schedule being related to said second merchant identity;
obtaining a lead identity of a lead for a first merchant and a second merchant;
sorting said first merchant and said second merchant by comparing said first merchant referral schedule and said second merchant referral schedule to a criterion of a referrer to identify a more preferred merchant from a set including said first merchant and said second merchant and a less preferred merchant from said set;
inquiring if said lead is not a member of said more preferred merchant by submitting said lead identity to said more preferred merchant; and
referring said lead to said more preferred merchant when said lead is not a member of said more preferred merchant.

2. The method according to claim 1, which further comprises referring said lead to said less preferred merchant when said lead is a member of said more preferred merchant.

3. The process according to claim 1, which further comprises:
defining a genus, said genus including said first merchant and said second merchant; and
delivering an advertisement for said genus to said lead.

4. The process according to claim 3, wherein said referrer delivers said advertisement to said lead.

5. The process according to claim 3, wherein said advertisement markets said first merchant and said second merchant.

6. The process according to claim 1, wherein:
said first merchant and said second merchant are dating services; and
said lead is a potential member of said dating services.

7. The process according to claim 1, wherein said advertisement is displayable on a computer.

8. The process according to claim 1, wherein said criterion is a referral payment.

9. The process according to claim 1, further comprising considering a signup rate of said first merchant and a signup rate of said second merchant when sorting said first merchant and said second merchant.

10. The process according to claim 1, which further comprises:
storing in said database when said referrer refers said lead to said first merchant and said lead pays said first merchant;
storing in said database when said referrer refers said lead to said second merchant and said lead pays said second merchant;
storing in said database when said referrer refers said lead to said first merchant and said lead does not pay said first merchant;
storing in said database when said referrer refers said lead to said second merchant and said lead does not pay said second merchant;
calculating a conversion rate of said first merchant by dividing a total number of converted leads for said first merchant by a total number of leads referred to said first merchant;
calculating a conversion rate of said second merchant by deriving a total number of converted leads for said second merchant by a total number of leads referred to said second merchant;
storing said conversion rate of said first merchant in said database and relating said conversion orate of said first merchant to said first merchant identifier;
storing said conversion rate of said second merchant in said database and relating said conversion rate of said second merchant to said second merchant identifier; and
considering said conversion rate of said first merchant and said conversion rate of said second merchant when sorting said first merchant and said second merchant.

11. A process for maximizing referral fees from online dating services, which comprises:
creating a database, said database storing a first online dating service identity, a second online dating service identity, a first-online dating service referral schedule, and a second-online dating service referral schedule, said first-online dating service referral schedule being related to said first online dating service identity, and said second online dating service referral schedule being related to said second online dating service identity;
creating an advertisement, said advertisement being generic for said first online dating service and said second online dating service;
receiving an email of a lead for said first online dating service and said second online dating service after said lead viewed said advertisement;
sorting said first online dating service and said second online dating service by comparing said first online dating service referral schedule and said second online dating service referral schedule to a criterion of a referrer to identify a most preferred online dating service from a set including said first online dating service and said second online dating service;
inquiring if said lead is not a subscriber of said most preferred online dating service by said referrer submitting said lead identity to said most preferred online dating service; and
referring said lead to said most preferred online dating service when said lead is not a subscriber of said most preferred online dating service.

12. The process according to claim 11, which further comprises:
determining a second most preferred online dating service when said first preferred online dating service indicates to said referrer that said lead is a subscriber of said most preferred online dating service;
inquiring if said lead is not a subscriber of said second most preferred online dating service by said referrer submitting said lead identity to said second most preferred online dating service; and
referring said lead to said second most preferred online dating service when said lead is not a subscriber of said second most preferred online dating service.

13. A process for a merchant to receive referrals, which comprises:
receiving a lead identifier from a referrer;
confirming with said referrer if a lead related to said lead identifier is already in a subscriber database of said merchant before said lead provides said lead identifier to said merchant; and
paying said referrer a referral fee when said lead subscribes with said merchant.

14. The process according to claim 13, wherein said merchant is an online dating service.

15. The process according to claim 13, wherein said lead identifier is an email address of said lead.
